(19) United States
(12) Patent Application Publication
(10) Pub. No.: US 2004/0249475 A1
(43) Pub. Date: Dec. 9, 2004

(54) Safety bus system, particularly for tabletting machines

(76) Inventor: Walter Hegel, Berlin (DE)

Correspondence Address: BIRCH STEWART KOLASCH & BIRCH, PO BOX 747, FALLS CHURCH, VA, 22040-0747, US

(21) Appl. No.: 10/805,242

(22) Filed: Mar. 22, 2004

(30) Foreign Application Priority Data
Mar. 21, 2003 (DE) 203 04 950.0

(51) Int. Cl. G05B 15/00

(52) U.S. Cl. 700/1; 710/100; 307/112

(57) ABSTRACT

A safety bus system especially for tabletting machines includes at least one bus-capable module, at least one bus controller and at least one bus line interconnecting the at least one bus-capable module and the at least one bus controller. At least one safety function can be implemented by the safety bus system. The at least one safety function may be performed essentially simultaneously with at least one control function and/or at least one measurement function.

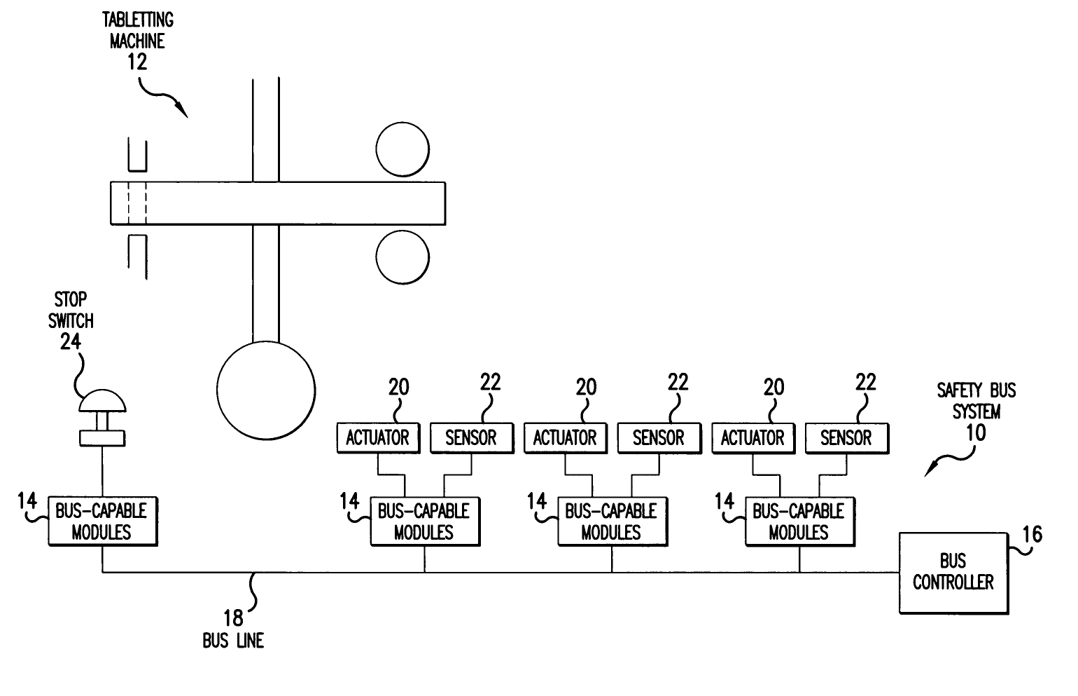

This Nonprovisional application claims priority under 35 U.S.C. § 119(a) on Patent Application No(s). 203 04 950.0 filed in Germany on Mar. 21, 2003, the entire contents of which are hereby incorporated by reference.

### BACKGROUND OF THE INVENTION

1. Field of the Invention

The present invention relates to a safety bus system, and more particularly, a safety bus system for tabletting machines.

2. Description of the Background Art

Bus systems are known to have the property that signals from sensors or actuators do not need to be wired to a programmable controller or to a data acquisition or control unit as individual signals, but instead are connected to diverse components, which in turn are connected to one another by a bus system, generally implemented as a two-wire or four-wire system. Such a system is known, for example, from EP 1 050 400 A3 for use in a rotary tabletting press, the entire contents of which are hereby incorporated by reference.

The advantage of such a technology is that the number of necessary lines is reduced, thus also reducing the cost of wiring. Moreover, as a result of the diversified distribution of the components, smaller control cabinets can be chosen. It is also frequently the goal to eliminate the control cabinet completely and distribute all of the control systems among the various subassemblies in the machine.

A disadvantage in the introduction of safety technology is that it has previously been virtually impossible to implement reliable functions, such as those used for personnel protection, with software or purely electronic systems, because they were subject to a requirement for reliable safety that can only be achieved at great expense, for example through the use of redundant subassemblies and different software on different target systems.

A further disadvantage of conventional wiring for safety systems is that two systems always exist: the electronic machine control program that governs the process and sequence, and the safety system that is of conventional design for safety reasons. It is necessary to create interfaces between the two systems in order to transfer information from one system to the other.

Moreover, hard-wired systems that do not have software are rigid systems which cannot be easily upgraded. This is a disadvantage because modern safety technology demands flexible safety concepts wherein the machine can assume a variety of states to which various different safety concepts apply under certain circumstances. This is all the more expensive with hard-wired safety technology because more subassemblies may have to be employed to accommodate the various requirements.

### SUMMARY OF THE INVENTION

Consequently, the object of the invention is to create a safety bus system that is more economical and has a lower failure rate than the prior art.

This object is attained by the present invention with a safety bus system comprising at least one bus-capable module and/or at least one bus controller and at least one bus line, wherein at least one safety function can be implemented and the at least one safety function and at least one control function and/or at least one measurement function can be performed essentially simultaneously. The combination of standard bus and safety bus achieves the advantage of heterogeneous requirements-based wiring. It is no longer necessary to create interfaces. In the area of safety, it is possible to embed and expand a variety of functions, permitting the realization of flexible safety concepts. Moreover, minimizing the number of wires leads to savings and a lower failure rate, as well as a reduction in the losses arising from wire length with direct wiring. The present invention also reduces the space needed for the wiring and the control cabinet.

Provision is made in a preferred embodiment of the invention that at least one analog signal can be processed by means of the at least one safety function and/or the at least one control function and/or the at least one measurement function. An especially broad and flexible area of application for the safety bus system is achieved in this way.

Provision is also made in a preferred embodiment of the invention that at least one digital or binary signal can be processed by means of the at least one safety function and/or the at least one control function and/or the at least one measurement function. In this way, a variety of functions can be implemented while minimizing the necessary transmission bandwidth.

Moreover, provision is made in a preferred embodiment of the invention that at least one of the at least one safety functions is a safety window, an enclosure switch, an emergency stop function or the like. This results in especially desirable implementation options, which are advantageously distinguished by diverse application options.

Furthermore, provision is made in a preferred embodiment of the invention that at least one of the at least one bus-capable modules includes at least one actuator and/or at least one sensor and/or at least one display means. In this way, a variety of possible advantageous applications can be implemented.

In addition, provision is made in a preferred embodiment of the invention that at least one of the at least one bus-capable modules includes at least one safety-related commanding means, and especially preferred that the at least one commanding means is a switch, button, emergency off switch, sensor or the like. A variety of possible safety functions is advantageously achievable in this way.

Moreover, provision is made in a preferred embodiment of the invention that at least one of the at least one bus-capable modules includes at least one safety-related signaling means, wherein at least one optical signal and/or at least one acoustic signal and/or at least one mechanical signal can advantageously be produced by the at least one signaling means. In this way, a variety of possible advantageous safety functions can be implemented.

Furthermore, provision is made in a preferred embodiment of the invention that at least one of the at least one bus-capable modules includes at least one safety-related actuator, wherein the at least one safety-related actuator is electromechanical, electromagnetic, piezoelectric, pneumatic, hydraulic, or the like. A variety of possible safety functions is advantageously achievable in this way.

Lastly, provision is made in a preferred embodiment of the invention that the at least one bus line is electrical, optical, radio-controlled or the like, wherein the at least one bus line preferably includes at least one signal line, since these implementation forms are distinguished by especially desirable transmission characteristics.

Further scope of applicability of the present invention will become apparent from the detailed description given hereinafter. However, it should be understood that the detailed description and specific examples, while indicating preferred embodiment of the invention, are given by way of illustration only, since various changes and modification within the spirit and scope of the invention will become apparent to those skilled in the art.

### BRIEF DESCRIPTION OF THE DRAWINGS

The invention is explained in detail below with reference to an example embodiment shown in the associated drawing figure, which shows a safety bus system with an emergency stop function for a tabletting machine.

### DETAILED DESCRIPTION OF THE PREFERRED EMBODIMENTS

The figure shows a safety bus system 10 according to the invention for use in a tabletting machine 12 with four bus-capable modules 14, a bus line 18, and a bus controller 16 in the form of a process control computer. In another design variant, a safety module having the contacts that implement the safety function may also be present in addition to the process control computer. The safety function may be a safety window, an enclosure switch, an emergency stop function, or the like.

Three of the bus-capable modules 14 have actuators 20 and sensors 22 for controlling the tabletting machine 12. Another bus-capable module 14 includes a safety-related commanding means, which is embodied in one form as an emergency stop switch 24 to implement an “emergency stop” safety function.

The bus-capable modules 14 may include one or more actuators, and/or one or more sensors, and/or one or more displays. The bus-capable modules 14 may include safety-related commanding means, such as a switch, button, emergency off switch, sensor or the like. The bus-capable modules 14 may include safety-related signaling means, which produce signals such as optical, acoustic, mechanical, or the like. The bus-capable modules 14 may include safety-related actuators which are, for example, electromechanical, electromagnetic, piezoelectric, pneumatic, hydraulic, or the like.

The bus line 18 may be embodied as a single-strand fiber-optic line. Another variant is an electrical implementation that has at least two conductors. The bus line 18 may be electrical, optical, radio-controlled, wireless, or the like.

The digital (binary) and analog measurement and control signals for the actuators 20 and sensors 22 are transmitted over the bus line 18, while the status of the emergency stop switch 24 is simultaneously queried and transmitted to the bus controller 16 through the bus line 18.

When the emergency stop switch 24 is actuated, the bus controller 16 detects this and can react immediately and apply an appropriate safety response. In detecting various states of the tabletting machine 12 by measuring different combinations of various machine characteristics with the sensors 22, when for example a failure occurs, an appropriate safety response that is tailored to this particular failure can be invoked and applied. The inventive means make possible the realization of a number of various flexible safety concepts. Moreover, minimizing the number of wires to one signal line results in financial savings and a lower failure rate, and optical transmission eliminates losses. Finally, the space needed for the wiring and the control cabinet is minimized.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

I claim:

1. A safety bus system comprising:
at least one bus-capable module;
at least one bus controller; and
at least one bus line interconnecting the at least one bus-capable module and the at least one bus controller,
wherein at least one safety function can be implemented by the safety bus system, and the at least one safety function may be performed essentially simultaneously with at least one control function and/or at least one measurement function.

2. The safety bus system of claim 1, wherein at least one analog signal may be processed by means of the at least one safety function and/or the at least one control function and/or the at least one measurement function.

3. The safety bus system of claim 1, wherein at least one digital signal may be processed by means of the at least one safety function and/or the at least one control function and/or the at least one measurement function.

4. The safety bus system of claim 1, wherein at least one of the at least one safety functions is a safety window, an enclosure switch, or an emergency stop function.

5. The safety bus system of claim 1, wherein at least one of the at least one bus-capable modules includes at least one actuator and/or at least one sensor and/or at least one display.

6. The safety bus system of claim 1, wherein at least one of the at least one bus-capable modules includes at least one commanding means.

7. The safety bus system of claim 6, wherein the at least one commanding means is a switch, button, emergency off switch, or sensor.

8. The safety bus system of claim 1, wherein at least one of the at least one bus-capable modules includes at least one signaling means.

9. The safety bus system of claim 8, wherein the at least one signaling means produces at least one optical signal and/or at least one acoustic signal and/or at least one mechanical signal.

10. The safety bus system of claim 1, wherein at least one of the at least one bus-capable modules includes at least one actuator.

11. The safety bus system of claim 10, wherein the at least one actuator is electromechanical, electromagnetic, piezoelectric, pneumatic, or hydraulic.

12. The safety bus system of claim 1, wherein the at least one bus line is electrical, optical, or radio-controlled.

13. The safety bus system of claim 1, wherein the at least one bus line includes at least one signal line.

14. A tabletting machine comprising a safety bus system according to claim 1.
